(19) United States
(12) Patent Application Publication
(10) Pub. No.: US 2024/0086264 A1
(43) Pub. Date: Mar. 14, 2024

(54) HARDWARE ADAPTIVE VEHICLE OS DESIGN ON MCU

(71) Applicant: Baidu USA LLC, Sunnyvale, CA (US)

(72) Inventors: Haofeng KOU, Sunnyvale, CA (US); Davy HUANG, Sunnyvale, CA (US); Manjiang ZHANG, Sunnyvale, CA (US); Helen K. PAN, Sunnyvale, CA (US)

(21) Appl. No.: 17/932,203

(22) Filed: Sep. 14, 2022

(51) Int. Cl. G06F 9/54; G07C 5/08

(52) U.S. Cl. CPC G06F 9/544; G07C 5/085

(57) ABSTRACT

In one embodiment, a vehicle operating system (VOS) that can be partially ported to different types of microcontroller units (MCUs) includes at least one multiprocessor unit (MPU) with an operating system kernel running thereon, and at least one microcontroller unit (MCU) with multiple cores. Each core includes a set of unified application programming interfaces (APIs) for loading one or more MCU drivers corresponding to a type of the MCU, and one or more I/O drivers corresponding to a type of each of the one or more I/O devices associated with the MCU. The set of unified APIs includes at least one API for each service, and can vertically integrate a device path for the service from a hardware layer of the core to the service layer of the core. The VOS further includes multiple pairs of hardware-protected memories associated with each core to enable interprocess communication between the cores.

### TECHNICAL FIELD

Embodiments of the present disclosure relate generally to vehicle operating systems. More particularly, embodiments of the disclosure relate to a vehicle operating system with customized services and applications that are easy to be migrated to different type of ECUs.

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

An ADV includes many hardware and software components that are managed by a vehicle operating system (VOS), which may run on one or more multiprocessor units (MPUs) and one or more microcontroller units (MCUs). One popular VOS is Linux, due to its friendliness to developers, and easiness of migration, expansion, revision, and upgrading.

However, Linux doesn't meet industry standards and certification requirements in terms of real-time performance and safety. One such standard is the AutoSAR standard, which is a very high standard that is not easy to meet. Many companies try to follow the AutoSAR standard in developing their own VOS, not to meet the standard per se, but to pass some less demanding certifications.

### BRIEF DESCRIPTION OF THE DRAWINGS

Embodiments of the disclosure are illustrated by way of example and not limitation in the figures of the accompanying drawings in which like references indicate similar elements.

FIG. 1 illustrates a vehicle operation system (VOS) in an autonomous driving vehicle according to an embodiment of the invention.

FIG. 2 further illustrates asymmetric multiprocessing (AMP) of the VOS according to one embodiment of the invention.

FIG. 3 further illustrates an MCU according to an embodiment of the invention.

FIG. 4 illustrates an example of vertically integrating the device path of a service on the MCU according to an embodiment of the invention.

FIG. 5 is a block diagram illustrating an autonomous driving vehicle according to one embodiment.

FIG. 6 is a block diagram illustrating an example of an autonomous driving vehicle according to one embodiment.

FIG. 7 is a block diagram illustrating an example of an autonomous driving system used with an autonomous driving vehicle according to one embodiment.

FIGS. 8A and 8B are block diagrams illustrating an example of a sensor unit according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, the disclosure describes embodiments of a vehicle operating system (VOS). The VOS includes at least one multiprocessor unit (MPU) with an operating system kernel running thereon, and at least one microcontroller unit (MCU) that includes multiple cores. Each core on the MCU includes a set of unified application programming interfaces (APIs) for loading one or more MCU drivers corresponding to a type of the MCU, as well as one or more I/O drivers corresponding to a type of each of the one or more I/O devices associated with the MCU. The set of unified APIs includes at least one API for each service, and can vertically integrate a device path for the service from a hardware layer of the core to the service layer of the core. The VOS further includes multiple pairs of hardware-protected memories associated with each core, including a pair of hardware-protected memories for each other core. The pair of hardware-protected memories includes a read memory and a write memory, and is accessible only by the core and a corresponding core of the rest of the multiple cores.

In an embodiment, each core includes one or more application tasks running in an application layer on top of the service layer of the core. The cores of the MCU can asynchronously communicate with each other via an interprocess protocol (IPC) at the application layer of each core.

In an embodiment, each service is a hard real-time service and is customized according to an industry standard, such as the AutoSAR standard. Similarly, each application task can be customized according to the industry standard.

In an embodiment, vertically integrating the device path for the service from the hardware layer of the core to the service layer of the core comprises loading one or more MCU drivers according to the type of the MCU and one or more I/O drivers according to the type of each of the one or more I/O devices.

The customized services and applications according to the AutoSAR standard can be migrated from one type of MCU to another type of MCU without any re-customization. The unified APIs that function as a hardware wrapper can ensure that the customized services and applications will work on the target MCU.

The other embodiments, functions, and advantages will be apparent from the accompanying drawings and from the detailed description that follows.

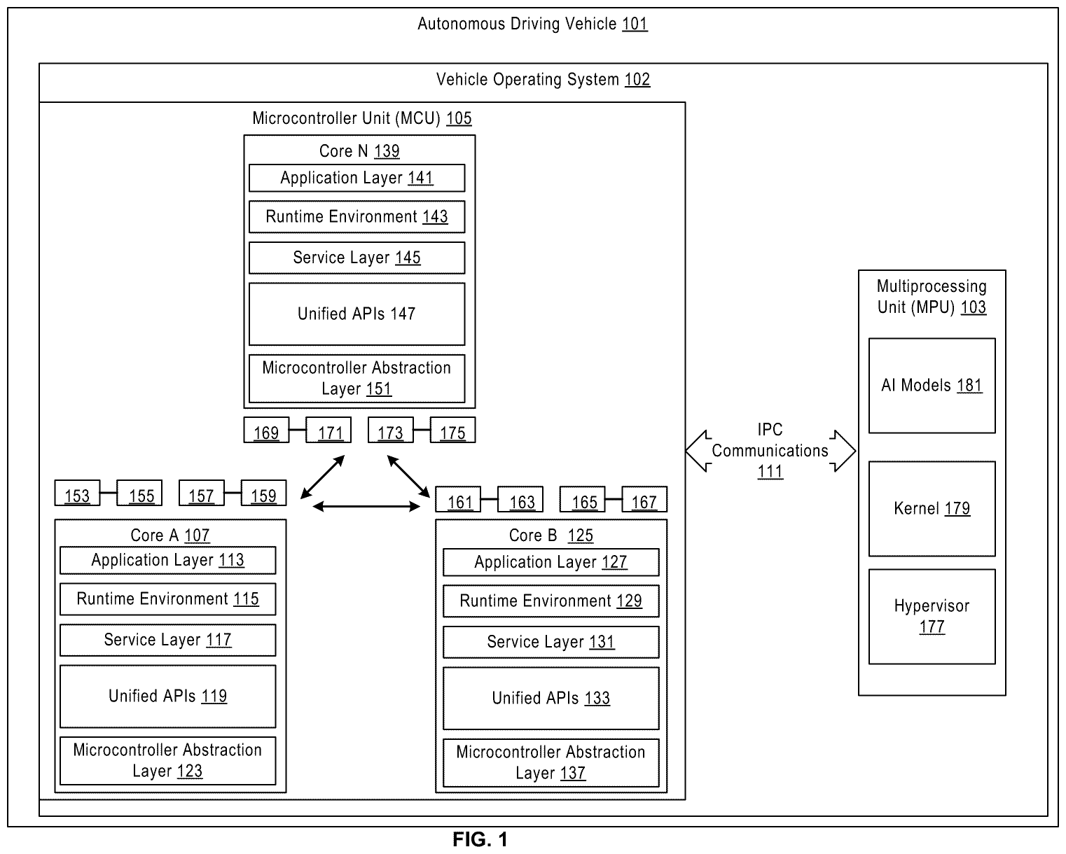

FIG. 1 illustrates a vehicle operation system (VOS) 102 in an autonomous driving vehicle 101 according to an embodiment of the invention.

As used herein and as shown in FIG. 1, the VOS 102 includes hardware and a software stack running on the hardware. The hardware of the VOS 102 includes an MPU 103 and an MCU 105. The software stack of the VOS 102 can be scattered across the MPU 103 and the MCU 105. The MPU 103 can include a kernel 179, and a hypervisor 177. The MCU 105 can include a microcontroller abstraction layer (MCAL) 123, 137, or 151; a set of unified APIs 119, 133, or 147; a service layer 117, 131, or 145; a runtime environment 115, 129, or 143; and an application layer 113, 127, or 141 on each of the three cores 107, 125, and 139.

The number of the MPUs, the number of the ECUs, and the number of cores on the MCU 105 are all provided for the purpose of illustrating the embodiments of the invention. In actual implementations, these numbers may be different.

The kernel 179 can be responsible for a number of kernel-level tasks, such as scheduling processes, device management, interrupt handling, memory management, and process management. The MPU 103 can communicate with the MCU 105 via interprocess communication (IPC) 111, such that the kernel 179 can schedule processes to run on the cores 107, 125, and 139.

In an embodiment, each of the cores 107, 125, and 139 of the MCU 105 can be a central processing unit (CPU), a graphical processing unit (GPU), a digital signal processor (DSP), or another type of processor, and can run the same set of services in their respective service layers 117, 131, and 145. Examples of services in the set of services on each core can include one or more of an Ethernet service, a memory service, a diagnostics service, a communication service, or an ECU state management.

Each of the services can be a service that has been customized according to an industry standard, such as the AutoSAR standard. Further, the number of the customized services can be adaptively adjusted based on a number of factors, such as the type of industry certification that the VOS needs to pass and the workload.

Each of the cores 107, 125, and 139 of the MCU 105 can also support implementation of custom functionality in their respective application layers 113, 127, and 141. Each application can include specific software components and applications that perform specific tasks as per instructions according to an industry standard such as AutoSAR. The number of applications and the type of the applications can also be adaptively adjusted based on the type of industry certification that the VOS needs to pass and user needs.

The runtime environments 115, 129, and 143 on the cores 107, 125, and 139 can be a middleware layer between the service layer and the application layer, and can provide communication services for the application layer.

Each of the MCALs 123, 137, and 257 implements an interface for the specific microcontroller. Each MCAL has layers of software that are integrated with the MCU 105 through registers, and can include drivers such as system drivers, diagnostics drivers, memory drivers, communication drivers (CAN, LIN, Ethernet, etc.), and I/O drivers.

In an embodiment, the MCU 105 can also include a board support package (BSP) (not shown) with hardware-specific boot firmware and other routines that allow the upper software applications to function in a given hardware environment.

The MCALs 123, 137, and 151 as well as the BSP are hardware dependent, which means that they are specific to the MCU 105, which can be one of multiple types. For example, the MCU 105 can be one of a programmable interface controller (PIC) microcontroller, an 8051 microcontroller, an Alf and Vegard's RISC (AVR) microcontroller, an Advanced RISC Machine (ARM) microcontroller, or a Renaissance Semiconductor for Advanced Solutions (Renesas) microcontroller.

In an embodiment, the set of unified APIs 119, 133, or, 147 can be used to load one or more MCU drivers corresponding to the type of the MCU drivers in the MCAL layer for each customized service in the service layer, and to load one or more I/O drivers for I/O devices associated with the MCU 105.

The MCU drivers as discussed above can include system drivers, diagnostics drivers, memory drivers, and communication drivers (CAN, LIN, Ethernet, etc.). These MCU drivers as well the I/O drivers are hardware dependent. Each type of MCU has a specific set of drivers, and each type I/O device has a specific set of I/O drivers.

In this disclosure, each MCAL can include drivers for multiple types of MCUs and multiple types of I/O devices. The number of types of MCUs and the of types of I/O devices can be adjusted and/or dynamically configured.

In this embodiment, the three cores 107, 125, and 129 are separated from each other at the level of the hardware, and can communicate with each other only at the application level. Thus, the three cores 107, 125, and 129, although on the same MCU 105, may have different MCU drivers and different I/O devices due to the architectural differences between each core at the hardware level.

Thus, the unified API on each core effectively integrates a device path for each service in the service layer on each core. Each service can have a path on the device (i.e., the core) across the multiple layers of software, including the MCAL and the service layer.

With such vertical integrations by the unified APIs on each core for each service, the set of services and the application tasks can run on any type of MCU and work with any I/O device with proper configurations, despite the hardware dependency of MCU drivers and the I/O drivers. The unified APIs effectively functions as a standard wrapper for the low-level details of the hardware on the MCU and the hardware of the cores.

In an embodiment, the unified APIs on each core are identical, the set of services on each core is also identical, while the application tasks on each core can be different. The services and the application tasks on each core can be scheduled by the kernel 179 on the MPU 103 but run asynchronously and independently from each other, such that there is no dependency between services on different cores, and no dependency between application tasks, to ensure hard real-time performance of the VOS 102.

In an embodiment, although the cores 107, 125, and 139 are separated at the hardware level, and the services and application tasks on the cores run independently and asynchronously, the cores can communicate with each other using IPC via hardware-protected memories. Each hardware-protected memory can be a region of memory that is protected at the hardware level to prevent access by unauthorized entities, e.g., unauthorized cores.

As shown in FIG. 1, each core has a set of hardware-protected memories, including a pair of hardware-protected memories for each other core on the CPU, and the pair of hardware-protected memories is accessible only to the core itself and the other core. The pair of hardware-protected memories include a write memory and a read memory.

Thus, in this embodiment with three cores, each core has two pairs of memories. For example, core 107 has 4 memories in two pairs, with one pair including memories 153 and 155, and the other including 157 and 159. The pair of memories 153 and 159 is designed for core 139, and, thus, is accessible to only core 107 and core 139. The pair of memories 157-159 is designated for core 125, and, thus, is accessible only to core 107 and core 125.

Core 125 also has two pairs of memories, with the first pair including 161 and 163 and designated for core 107, and the second pair including 165 and 167 and designed for core 139. Similarly, core 139 has two pair of memories, with the first pair including 169 and 171 and designated for core 107, and the second pair including 173 and 175 and designed for core 125.

These hardware-protected memories serve as message queues, allowing the cores to communicate with each other via IPC at the application level. However, the services and applications on the cores run in parallel with interdependency and waiting on each other for hard real-time performance.

In an embodiment, one or more artificial intelligence (AI) models 181 can run on a virtual machine created by a hypervisor 177 on the MPU 103. The AI models 181 can be trained using data collected from MCUs in multiple ADVs, and can then be applied to the ADV 101 for inference to maximize the performance of the VOS 102.

In the ADV 101, each MCU includes one or more hardware counters and one or more software counters that can collect information from the ADV 101, such as vehicle temperature, power consumption, times of writing to the storage, and application tasks running. A system monitor can receive the collected information from the various counters. Some of the collected information may be manually labeled if necessary. The collected information then can be stored in a cloud for use in training the one or more AI models 181.

In an embodiment, the AI models 181 can be used for prediction and classification. For example, the AI models 181 can predict when the vehicle temperature can reach a peak based on information available, and accordingly schedule tasks to reduce the temperature in advance to prevent the vehicle from running in extremely high temperatures. Similarly, the AI models 181 can schedule application tasks in a manner to avoid excessive writes to the storage, and to avoid unnecessary power consumption to prolong the life of the battery in the ADV 101.

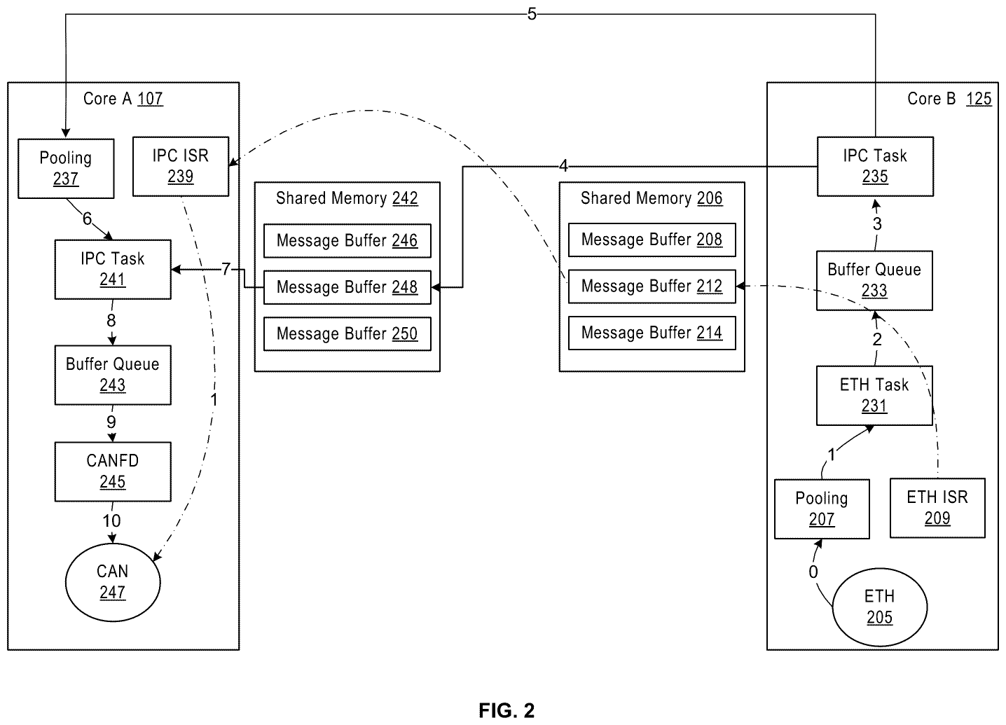

FIG. 2 further illustrates asymmetric multiprocessing (AMP) of the VOS 102 according to one embodiment of the invention.

The AMP illustrated in this embodiment is performed by the MCU 105 with three cores as shown in FIG. 1, and each core may have a different architecture or the same architecture. Thus, the MCU 105 can be a heterogeneous or homogeneous multicore system.

FIG. 2 shows core 107 and core 125 to illustrate the communication between the two cores. Each of cores 107 and 125 has its own address space, except that some memory spaces 242 and 206 may be shared between the two cores.

The shared memory 242 associated with core 107 can include the hardware-protected read memory 157 and the hardware-protected write memory 159 designated for core 125. Thus, core 125 has read access to memory 157, and write access to memory 159. Accordingly, core 107 has read access to memory 159 to retrieve messages written to the memory by core 125, and has write access to memory 157 to put data therein for core 125 to read.

As shown in FIG. 2, each of message buffers 206-214 and message buffers 242-250 can be hardware-implemented protected memory. Each of the memories 157 and 159 can be one of the message buffers in the shared memory 242.

In FIG. 2, when core B receives an Ethernet packet, an Ethernet task 231 can obtain it from an Ethernet driver 205 via a pooling process 207, and put it on a buffer queue 233. Then an IPC task 235 can be triggered to put the Ethernet packet in the shared memory 242 of core A 107, and to inform core A of the incoming data for core A 107. Core B 126 can then request an interrupt for core A to take over.

Core A 107 can retrieve the Ethernet packet from the shared memory 242 upon receiving an IPC task 241 through a pooling process 237. The Ethernet packet can be received by a CAN bus service 247 from a buffer queue 243 using controller area network flexible data-rate (CANFD) 245.

In an alternative embodiment, through optimization via the AI models 181, the Ethernet packet may take a shorter and faster route via an Ethernet interrupt service routine (ISR) 209, a local message buffer 202, and an IPC ISR 239.

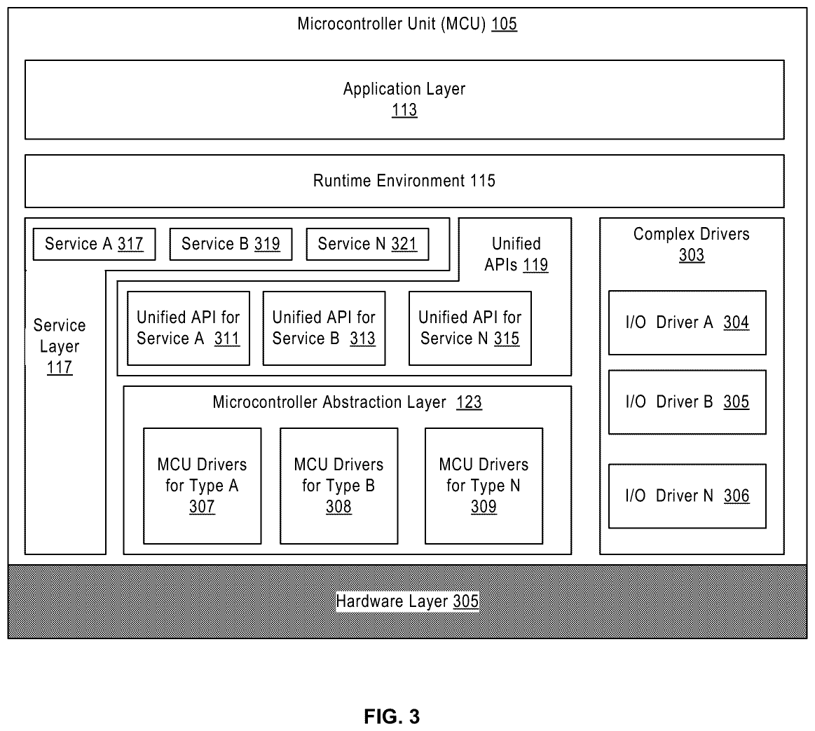

FIG. 3 further illustrates the MCU 105 according to an embodiment of the invention. More particularly, FIG. 3 shows the software stack on core 107.

As shown, the MCAL 123 includes a set of MCU drivers for each service for each type of a number of types of MCUs. For example, MCU drivers 307 are for type A MCU, and include one or more drivers for each service 317, 319, or 321 in the server layer 117. Similarly, MCU drivers 308 are for type B MCU, and include one or more drivers for each of the services, and MCU drivers 309 are for type N MCU, and include one or more drivers for each of the services.

Each type of MCU can have a different hardware architecture. For example, if the MCU 105 is a type A MCU (e.g., TC37 MCU), then the MCU drivers 307 would be the corresponding MCU drivers for the services 317, 319, and 321, and can be used to handle requirements of the various services at a hardware layer 305 of the MCU 105.

The software stack also includes multiple complex drivers 303, which are I/O drivers for I/O devices from various vendors. For example, the complex drivers 303 can include I/O driver A 304, B 305, and N 306. Depending on an I/O device used by the MCU 105, a particular I/O driver corresponding to the I/O device can be loaded.

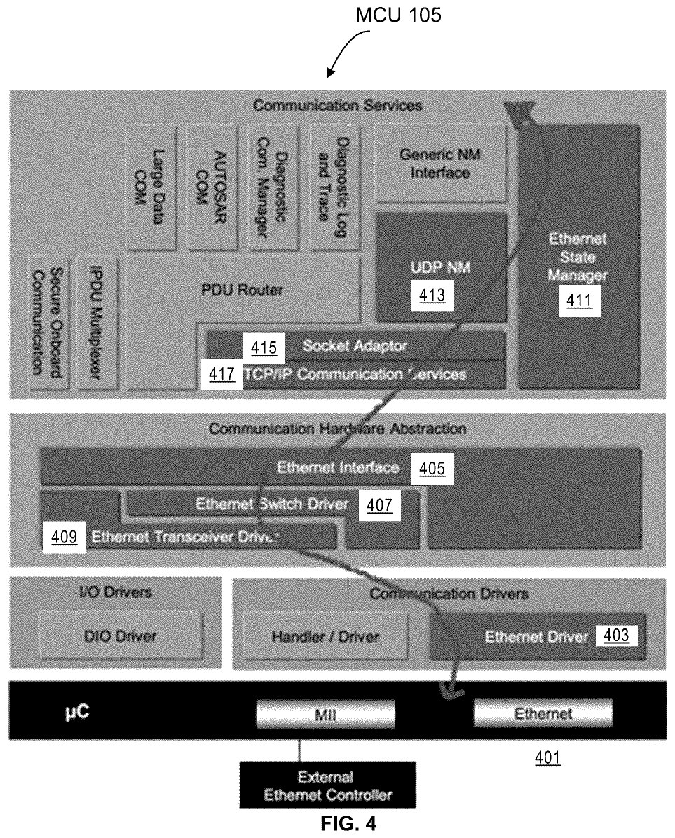

FIG. 4 illustrates an example of vertically integrating the device path of a service on the MCU 105 according to an embodiment of the invention. In this embodiment, the Ethernet service is used as an example to illustrate how the device path of a service is vertically integrated.

As shown in FIG. 4, a unified Ethernet interface 405 can be provided to load an Ethernet driver 403 corresponding to the type of the MCU 105. Further, I/O drivers 407 and 409 can also be loaded by the unified Ethernet interface 405 depending on the vendor that manufactures the I/O devices (i.e., the Ethernet switch and the Ethernet transceiver). The Ethernet interface 405 is unified because the same interface 405 is used across the VOS 102.

Below the Ethernet interface 405, the I/O drivers 407 and 409 as well as the Ethernet MCU driver 404 are loaded, and above the Ethernet interface 405, a variety of components 413, 414, 415, and 417 of the Ethernet service can be supported by the MCU 105 due to the loading of the corresponding drivers 403, 405, 407, and 409. Thus, the Ethernet interface effectively integrates the path of the Ethernet service vertically on the MCU device across the software stacks.

One or more of the various components 413, 414, 415, and 417 of the Ethernet service can be customized according to an industry standard such as AutoSAR based on the certification needs of a user (e.g., a car manufacturer).

Since the Ethernet interface 405 is unified across the VOS 102, it can be deployed to multiple types of MCUs with different hardware architectures to support the Ethernet service on those types of MCUs, which makes the customized components of the Ethernet service portable to many other types of MCUs as long as appropriate drivers are provided.

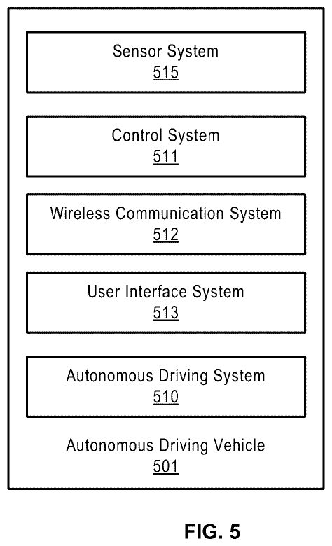

FIG. 5 is a block diagram illustrating an autonomous driving vehicle according to one embodiment of the disclosure. Referring to FIG. 5, autonomous driving vehicle 501 may be the same as ADV 101, and can be communicatively coupled to one or more servers over a network, which may be any type of networks such as a local area network (LAN), a wide area network (WAN) such as the Internet, a cellular network, a satellite network, or a combination thereof, wired or wireless. The server(s) may be any kind of servers or a cluster of servers, such as Web or cloud servers, application servers, backend servers, or a combination thereof. A server may be a data analytics server, a content server, a traffic information server, a map and point of interest (MPOI) server, or a location server, etc.

An autonomous driving vehicle refers to a vehicle that can be configured to in an autonomous mode in which the vehicle navigates through an environment with little or no input from a driver. Such an autonomous driving vehicle can include a sensor system having one or more sensors that are configured to detect information about the environment in which the vehicle operates. The vehicle and its associated controller(s) use the detected information to navigate through the environment. Autonomous driving vehicle 501 can operate in a manual mode, a full autonomous mode, or a partial autonomous mode.

In one embodiment, autonomous driving vehicle 501 includes, but is not limited to, autonomous driving system (ADS) 510, vehicle control system 511, wireless communication system 512, user interface system 513, and sensor system 515. Autonomous driving vehicle 501 may further include certain common components included in ordinary vehicles, such as, an engine, wheels, steering wheel, transmission, etc., which may be controlled by vehicle control system 511 and/or ADS 510 using a variety of communication signals and/or commands, such as, for example, acceleration signals or commands, deceleration signals or commands, steering signals or commands, braking signals or commands, etc.

Components 510-515 may be communicatively coupled to each other via an interconnect, a bus, a network, or a combination thereof. For example, components 510-515 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

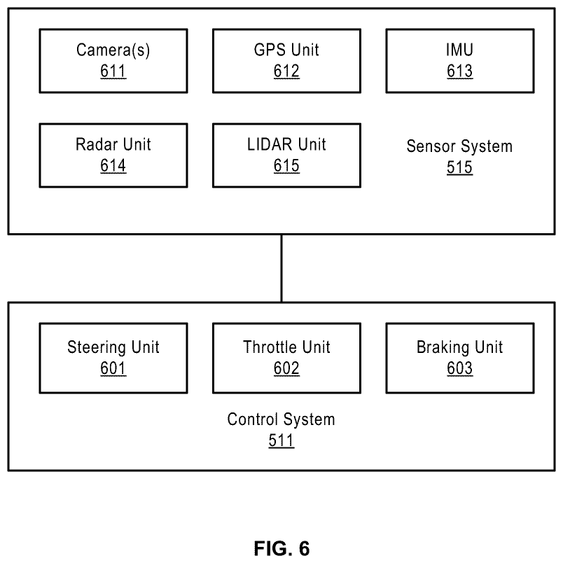

Referring now to FIG. 6, in one embodiment, sensor system 515 includes, but it is not limited to, one or more cameras 611, global positioning system (GPS) unit 612, inertial measurement unit (IMU) 613, radar unit 614, and a light detection and range (LIDAR) unit 615. GPS system 612 may include a transceiver operable to provide information regarding the position of the autonomous driving vehicle. IMU unit 613 may sense position and orientation changes of the autonomous driving vehicle based on inertial acceleration. Radar unit 614 may represent a system that utilizes radio signals to sense objects within the local environment of the autonomous driving vehicle. In some embodiments, in addition to sensing objects, radar unit 614 may additionally sense the speed and/or heading of the objects. LIDAR unit 615 may sense objects in the environment in which the autonomous driving vehicle is located using lasers. LIDAR unit 615 could include one or more laser sources, a laser scanner, and one or more detectors, among other system components. Cameras 611 may include one or more devices to capture images of the environment surrounding the autonomous driving vehicle. Cameras 611 may be still cameras and/or video cameras. A camera may be mechanically movable, for example, by mounting the camera on a rotating and/or tilting a platform.

Sensor system 515 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous driving vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 511 includes, but is not limited to, steering unit 601, throttle unit 602 (also referred to as an acceleration unit), and braking unit 603. Steering unit 601 is to adjust the direction or heading of the vehicle. Throttle unit 602 is to control the speed of the motor or engine that in turn controls the speed and acceleration of the vehicle. Braking unit 603 is to decelerate the vehicle by providing friction to slow the wheels or tires of the vehicle. Note that the components as shown in FIG. 6 may be implemented in hardware, software, or a combination thereof.

Referring back to FIG. 5, wireless communication system 512 is to allow communication between autonomous driving vehicle 501 and external systems, such as devices, sensors, other vehicles, etc. For example, wireless communication system 512 can wirelessly communicate with one or more devices directly or via a communication network. Wireless communication system 512 can use any cellular communication network or a wireless local area network (WLAN), e.g., using WiFi to communicate with another component or system. Wireless communication system 512 could communicate directly with a device (e.g., a mobile device of a passenger, a display device, a speaker within vehicle 501), for example, using an infrared link, Bluetooth, etc. User interface system 513 may be part of peripheral devices implemented within vehicle 501 including, for example, a keyboard, a touch screen display device, a microphone, and a speaker, etc.

Some or all of the functions of autonomous driving vehicle 501 may be controlled or managed by ADS 510, especially when operating in an autonomous driving mode. ADS 510 includes the necessary hardware (e.g., processor(s), memory, storage) and software (e.g., operating system, planning and routing programs) to receive information from sensor system 515, control system 511, wireless communication system 512, and/or user interface system 513, process the received information, plan a route or path from a starting point to a destination point, and then drive vehicle 501 based on the planning and control information. Alternatively, ADS 510 may be integrated with vehicle control system 511.

For example, a user as a passenger may specify a starting location and a destination of a trip, for example, via a user interface. ADS 510 obtains the trip related data. For example, ADS 510 may obtain location and route data from an MPOI server. The location server provides location services and the MPOI server provides map services and the POIs of certain locations. Alternatively, such location and MPOI information may be cached locally in a persistent storage device of ADS 510.

While autonomous driving vehicle 501 is moving along the route, ADS 510 may also obtain real-time traffic information from a traffic information system or server (TIS). Note that the servers may be operated by a third party entity. Alternatively, the functionalities of the servers may be integrated with ADS 510. Based on the real-time traffic information, MPOI information, and location information, as well as real-time local environment data detected or sensed by sensor system 515 (e.g., obstacles, objects, nearby vehicles), ADS 510 can plan an optimal route and drive vehicle 501, for example, via control system 511, according to the planned route to reach the specified destination safely and efficiently.

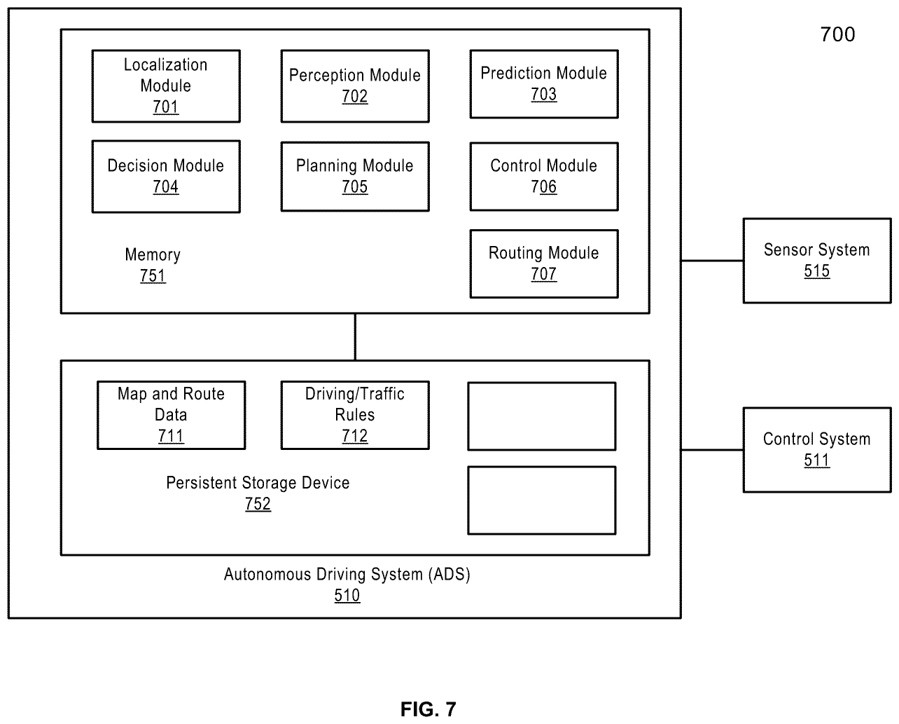

FIG. 7 is a block diagram illustrating an example of an autonomous driving system used with an autonomous driving vehicle according to one embodiment. System 700 may be implemented as a part of autonomous driving vehicle 501 of FIG. 5 including, but is not limited to, ADS 510, control system 511, and sensor system 515. Referring to FIG. 7, ADS 510 includes, but is not limited to, localization module 701, perception module 702, prediction module 703, decision module 704, planning module 705, control module 706, and routing module 707.

Some or all of modules 701-707 may be implemented in software, hardware, or a combination thereof. For example, these modules may be installed in persistent storage device 752, loaded into memory 751, and executed by one or more processors (not shown). Note that some or all of these modules may be communicatively coupled to or integrated with some or all modules of vehicle control system 511 of FIG. 7. Some of modules 701-707 may be integrated together as an integrated module.

Localization module 701 determines a current location of autonomous driving vehicle 501 (e.g., leveraging GPS unit 712) and manages any data related to a trip or route of a user. Localization module 701 (also referred to as a map and route module) manages any data related to a trip or route of a user. A user may log in and specify a starting location and a destination of a trip, for example, via a user interface. Localization module 701 communicates with other components of autonomous driving vehicle 501, such as map and route data 711, to obtain the trip related data. For example, localization module 701 may obtain location and route data from a location server and a map and POI (MPOI) server. A location server provides location services and an MPOI server provides map services and the POIs of certain locations, which may be cached as part of map and route data 711. While autonomous driving vehicle 501 is moving along the route, localization module 701 may also obtain real-time traffic information from a traffic information system or server.

Based on the sensor data provided by sensor system 515 and localization information obtained by localization module 701, a perception of the surrounding environment is determined by perception module 702. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 702 may include a computer vision system or functionalities of a computer vision system to process and analyze images captured by one or more cameras in order to identify objects and/or features in the environment of autonomous driving vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 702 can also detect objects based on other sensors data provided by other sensors such as a radar and/or LIDAR.

For each of the objects, prediction module 703 predicts what the object will behave under the circumstances. The prediction is performed based on the perception data perceiving the driving environment at the point in time in view of a set of map/rout information 711 and traffic rules 712. For example, if the object is a vehicle at an opposing direction and the current driving environment includes an intersection, prediction module 703 will predict whether the vehicle will likely move straight forward or make a turn. If the perception data indicates that the intersection has no traffic light, prediction module 703 may predict that the vehicle may have to fully stop prior to enter the intersection. If the perception data indicates that the vehicle is currently at a left-turn only lane or a right-turn only lane, prediction module 703 may predict that the vehicle will more likely make a left turn or right turn respectively.

For each of the objects, decision module 704 makes a decision regarding how to handle the object. For example, for a particular object (e.g., another vehicle in a crossing route) as well as its metadata describing the object (e.g., a speed, direction, turning angle), decision module 704 decides how to encounter the object (e.g., overtake, yield, stop, pass). Decision module 704 may make such decisions according to a set of rules such as traffic rules or driving rules 712, which may be stored in persistent storage device 752.

Routing module 707 is configured to provide one or more routes or paths from a starting point to a destination point. For a given trip from a start location to a destination location, for example, received from a user, routing module 707 obtains route and map information 711 and determines all possible routes or paths from the starting location to reach the destination location. Routing module 707 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 704 and/or planning module 705. Decision module 704 and/or planning module 705 examine all of the possible routes to select and modify one of the most optimal routes in view of other data provided by other modules such as traffic conditions from localization module 701, driving environment perceived by perception module 702, and traffic condition predicted by prediction module 703. The actual path or route for controlling the ADV may be close to or different from the reference line provided by routing module 707 dependent upon the specific driving environment at the point in time.

Based on a decision for each of the objects perceived, planning module 705 plans a path or route for the autonomous driving vehicle, as well as driving parameters (e.g., distance, speed, and/or turning angle), using a reference line provided by routing module 707 as a basis. That is, for a given object, decision module 704 decides what to do with the object, while planning module 705 determines how to do it. For example, for a given object, decision module 704 may decide to pass the object, while planning module 705 may determine whether to pass on the left side or right side of the object. Planning and control data is generated by planning module 705 including information describing how vehicle 501 would move in a next moving cycle (e.g., next route/path segment). For example, the planning and control data may instruct vehicle 501 to move 10 meters at a speed of 30 mile per hour (mph), then change to a right lane at the speed of 25 mph.

Based on the planning and control data, control module 706 controls and drives the autonomous driving vehicle, by sending proper commands or signals to vehicle control system 511, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 705 plans a next route segment or path segment, for example, including a target position and the time required for the ADV to reach the target position. Alternatively, planning module 705 may further specify the specific speed, direction, and/or steering angle, etc. In one embodiment, planning module 705 plans a route segment or path segment for the next predetermined period of time such as 5 seconds. For each planning cycle, planning module 705 plans a target position for the current cycle (e.g., next 5 seconds) based on a target position planned in a previous cycle. Control module 706 then generates one or more control commands (e.g., throttle, brake, steering control commands) based on the planning and control data of the current cycle.

Note that decision module 704 and planning module 705 may be integrated as an integrated module. Decision module 704/planning module 705 may include a navigation system or functionalities of a navigation system to determine a driving path for the autonomous driving vehicle. For example, the navigation system may determine a series of speeds and directional headings to affect movement of the autonomous driving vehicle along a path that substantially avoids perceived obstacles while generally advancing the autonomous driving vehicle along a roadway-based path leading to an ultimate destination. The destination may be set according to user inputs via user interface system 513. The navigation system may update the driving path dynamically while the autonomous driving vehicle is in operation. The navigation system can incorporate data from a GPS system and one or more maps so as to determine the driving path for the autonomous driving vehicle.

According to one embodiment, a system architecture of an autonomous driving system as described above includes, but it is not limited to, an application layer, a planning and control (PNC) layer, a perception layer, a device driver layer, a firmware layer, and a hardware layer. The application layer may include user interface or configuration application that interacts with users or passengers of an autonomous driving vehicle, such as, for example, functionalities associated with user interface system 513. The PNC layer may include functionalities of at least planning module 705 and control module 706. The perception layer may include functionalities of at least perception module 702. In one embodiment, there is an additional layer including the functionalities of prediction module 703 and/or decision module 704. Alternatively, such functionalities may be included in the PNC layer and/or the perception layer. The firmware layer may represent at least the functionality of sensor system 515, which may be implemented in a form of a field programmable gate array (FPGA). The hardware layer may represent the hardware of the autonomous driving vehicle such as control system 511. The application layer, PNC layer, and perception layer can communicate with the firmware layer and hardware layer via the device driver layer.

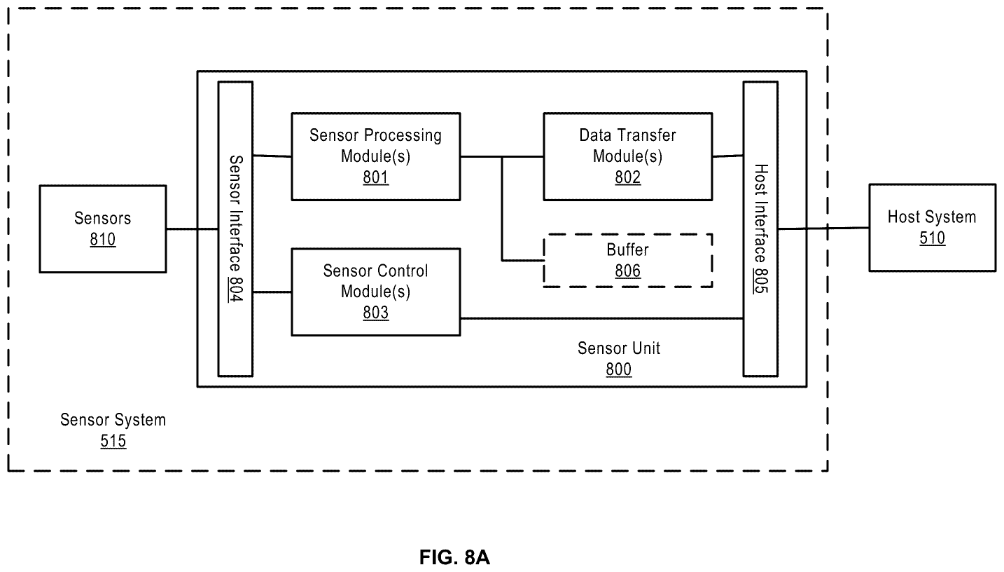

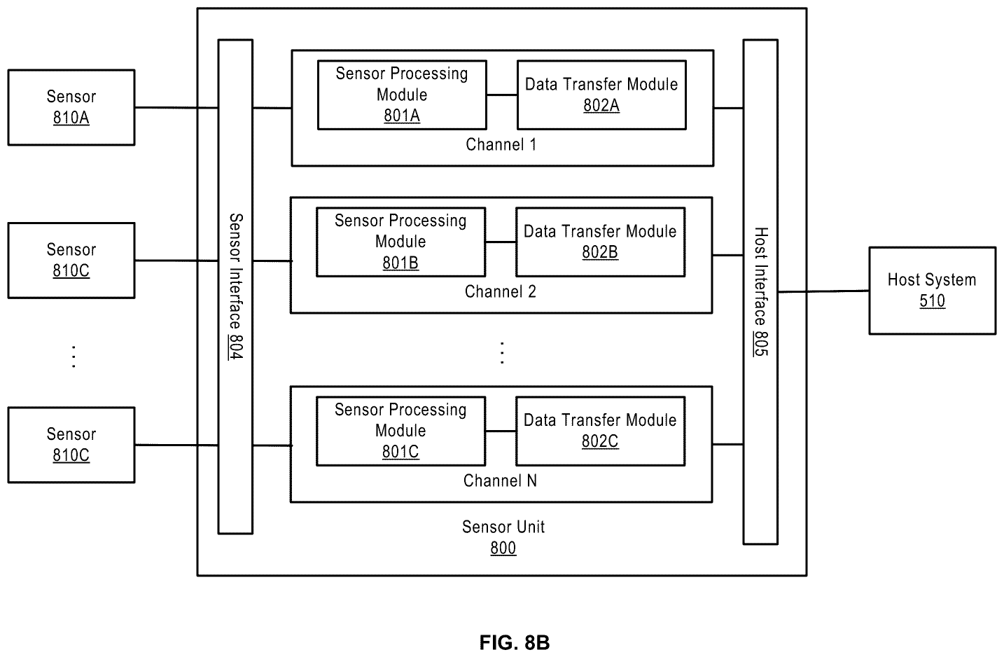

FIG. 8A is a block diagram illustrating an example of a sensor system according to one embodiment of the invention. Referring to FIG. 8A, sensor system 515 includes a number of sensors 810 and a sensor unit 800 coupled to host system 510. Host system 510 represents a planning and control system as described above, which may include at least some of the modules as shown in FIG. 7. Sensor unit 800 may be implemented in a form of an FPGA device or an ASIC (application specific integrated circuit) device. In one embodiment, sensor unit 800 includes, amongst others, one or more sensor data processing modules 801 (also simply referred to as sensor processing modules), data transfer modules 802, and sensor control modules or logic 803. Modules 801-803 can communicate with sensors 810 via a sensor interface 804 and communicate with host system 510 via host interface 805. Optionally, an internal or external buffer 806 may be utilized for buffering the data for processing.

In one embodiment, for the receiving path or upstream direction, sensor processing module 801 is configured to receive sensor data from a sensor via sensor interface 804 and process the sensor data (e.g., format conversion, error checking), which may be temporarily stored in buffer 806. Data transfer module 802 is configured to transfer the processed data to host system 510 using a communication protocol compatible with host interface 805. Similarly, for the transmitting path or downstream direction, data transfer module 802 is configured to receive data or commands from host system 510. The data is then processed by sensor processing module 801 to a format that is compatible with the corresponding sensor. The processed data is then transmitted to the sensor.

In one embodiment, sensor control module or logic 803 is configured to control certain operations of sensors 810, such as, for example, timing of activation of capturing sensor data, in response to commands received from host system (e.g., perception module 702) via host interface 805. Host system 510 can configure sensors 810 to capture sensor data in a collaborative and/or synchronized manner, such that the sensor data can be utilized to perceive a driving environment surrounding the vehicle at any point in time.

Sensor interface 804 can include one or more of Ethernet, USB (universal serial bus), LTE (long term evolution) or cellular, WiFi, GPS, camera, CAN, serial (e.g., universal asynchronous receiver transmitter or UART), SIM (subscriber identification module) card, and other general purpose input/output (GPIO) interfaces. Host interface 805 may be any high speed or high bandwidth interface such as PCIe (peripheral component interconnect or PCI express) interface. Sensors 810 can include a variety of sensors that are utilized in an autonomous driving vehicle, such as, for example, a camera, a LIDAR device, a RADAR device, a GPS receiver, an IMU, an ultrasonic sensor, a GNSS (global navigation satellite system) receiver, an LTE or cellular SIM card, vehicle sensors (e.g., throttle, brake, steering sensors), and system sensors (e.g., temperature, humidity, pressure sensors), etc.

For example, a camera can be coupled via an Ethernet or a GPIO interface. A GPS sensor can be coupled via a USB or a specific GPS interface. Vehicle sensors can be coupled via a CAN interface. A RADAR sensor or an ultrasonic sensor can be coupled via a GPIO interface. A LIDAR device can be coupled via an Ethernet interface. An external SIM module can be coupled via an LTE interface. Similarly, an internal SIM module can be inserted onto a SIM socket of sensor unit 800. The serial interface such as UART can be coupled with a console system for debug purposes.

Note that sensors 810 can be any kind of sensors and provided by various vendors or suppliers. Sensor processing module 801 is configured to handle different types of sensors and their respective data formats and communication protocols. According to one embodiment, each of sensors 810 is associated with a specific channel for processing sensor data and transferring the processed sensor data between host system 510 and the corresponding sensor. Each channel includes a specific sensor processing module and a specific data transfer module that have been configured or programmed to handle the corresponding sensor data and protocol, as shown in FIG. 8B.

Referring now to FIG. 8B, sensor processing modules 801A-801C are specifically configured to process sensor data obtained from sensors 810A-810C respectively. Note that sensors 810A-810C may the same or different types of sensors. Sensor processing modules 801A-801C can be configured (e.g., software configurable) to handle different sensor processes for different types of sensors. For example, if sensor 810A is a camera, processing module 801A can be figured to handle pixel processing operations on the specific pixel data representing an image captured by camera 810A. Similarly, if sensor 810A is a LIDAR device, processing module 801A is configured to process LIDAR data specifically. That is, according to one embodiment, dependent upon the specific type of a particular sensor, its corresponding processing module can be configured to process the corresponding sensor data using a specific process or method corresponding to the type of sensor data.

Similarly, data transfer modules 802A-802C can be configured to operate in different modes, as different kinds of sensor data may be in different size or sensitivities that require different speed or timing requirement. According to one embodiment, each of data transfer modules 802A-802C can be configured to operate in one of a low latency mode, a high bandwidth mode, and a memory mode (also referred to as a fixed memory mode).

When operating in a low latency mode, according to one embodiment, a data transfer module (e.g., data transfer module 802) is configured to send the sensor data received from a sensor to the host system as soon as possible without or with minimum delay. Some of sensor data are very sensitive in terms of timing that need to be processed as soon as possible. Examples of such sensor data include vehicle status such as vehicle speed, acceleration, steering angle, etc.

When operating in a high bandwidth mode, according to one embodiment, a data transfer module (e.g., data transfer module 802) is configured to accumulate the sensor data received from a sensor up to a predetermined amount, but is still within the bandwidth the connection between the data transfer module and the host system 510. The accumulated sensor data is then transferred to the host system 510 in a batch that maximum the bandwidth of the connection between the data transfer module and host system 510. Typically, the high bandwidth mode is utilized for a sensor that produces a large amount of sensor data. Examples of such sensor data include camera pixel data.

When operating in a memory mode, according to one embodiment, a data transfer module is configured to write the sensor data received from a sensor directly to a memory location of a mapped memory of host system 510, similar to a shared memory page. Examples of the sensor data to be transferred using memory mode include system status data such as temperature, fans speed, etc.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A microcontroller unit (MCU) in an autonomous driving vehicle (ADV), comprising:
a plurality of cores, wherein each of the plurality of cores includes a set of unified application programming interfaces (APIs), wherein each of the set of unified APIs vertically integrates a device path for one of a plurality of services from a hardware layer of the core to a service layer of the core;
a plurality of pairs of hardware-protected memories associated with each of the plurality of cores, wherein the plurality of pairs of hardware-protected memories includes a pair of hardware-protected memories for each of the rest of the plurality of cores, wherein the pair of hardware-protected memories includes a read memory and a write memory, and are accessible only by the core and a corresponding core of the rest of the plurality of cores.

2. The MCU of claim 1, wherein the MCU communicates with a multiprocessor unit (MPU) in the ADV, wherein the MPU communicates with the MCU via interprocessing unit (IPC), wherein the MPU includes an operating system kernel running thereon.

3. The MCU of claim 1, wherein each of plurality of cores includes one or more application tasks running in an application layer on top of the service layer of the core, wherein the plurality of cores asynchronously communicate with each other via an interprocess protocol (IPC) at the application layer of each core.

4. The MCU of claim 1, wherein each of the plurality of services is a hard real-time service.

5. The MCU of claim 3, wherein each of the plurality of services is a customized service according to an industry standard, and wherein each of the one or more application tasks is customized application task according to the industry standard.

6. The MCU of claim 5, wherein the industry standard is Automotive Open System Architecture (autoSAR).

7. The MCU of claim 1, wherein vertically integrating the device path for the service from the hardware layer of the core to the service layer of the core comprises loading one or more MCU drivers according to a type of the MCU and one or more of I/O drivers according to a type of each of one or more I/O devices associated with the MCU.

8. The MCU of claim 1, wherein the plurality of services include one or more of an Ethernet service, a memory service, a communication service, a diagnostics service, or an ECU statement management service.

9. The MCU of claim 2, wherein the operating system kernel running on the MPU is a Linux kernel.

10. The MCU of claim 1, wherein the plurality of cores communicate with each other via the plurality of pairs of hardware-protected memories.

11. An autonomous driving vehicle (ADV), comprising:
a microcontroller unit (MCU), wherein the MCU comprises:
a plurality of cores, wherein each of the plurality of cores includes a set of unified application programming interfaces (APIs), wherein each of the set of unified APIs vertically integrates a device path for one of a plurality of services from a hardware layer of the core to a service layer of the core;
a plurality of pairs of hardware-protected memories associated with each of the plurality of cores, wherein the plurality of pairs of hardware-protected memories include a pair of hardware-protected memories for each of the rest of the plurality of cores, wherein the pair of hardware-protected memories includes a read memory and a write memory, and are accessible only by the core and a corresponding core of the rest of the plurality of cores.

12. The ADV of claim 11, wherein the MCU further comprises:
a multiprocessor unit (MPU) with an operating system kernel running thereon, wherein the MPU communicates with the MCU via interprocess communication (IPC).

13. The ADV of claim 11, wherein each of plurality of cores includes one or more application tasks running in an application layer on top of the service layer of the core, wherein the plurality of cores asynchronously communicate with each other via an interprocess protocol (IPC) at the application layer of each core.

14. The ADV of claim 11, wherein each of the plurality of services is a hard real-time service.

15. The ADV of claim 13, wherein each of the plurality of services is a customized service according to an industry standard, and wherein each of the one or more application tasks is customized application task according to the industry standard.

16. The ADV of claim 15, wherein the industry standard is Automotive Open System Architecture (autoSAR).

17. The ADV of claim 11, wherein vertically integrating the device path for the service from the hardware layer of the core to the service layer of the core comprises loading one or more MCU drivers according to a type of the MCU and one or more of I/O drivers according to a type of each of one or more I/O devices associated with the MCU.

18. The ADV of claim 11, wherein the plurality of services include one or more of an Ethernet service, a memory service, a communication service, a diagnostics service, or an ECU statement management service.

19. The ADV of claim 12, wherein the operating system kernel running on the MPU is a Linux kernel.

20. The ADV of claim 11, wherein the plurality of cores communicate with each other via the plurality of pairs of hardware-protected memories.
